(19) United States
(12) Patent Application Publication
(10) Pub. No.: US 2023/0297728 A1
(43) Pub. Date: Sep. 21, 2023

(54) MULTI-USER COLLABORATION SYSTEM FOR GENERATIVE DESIGNS

(71) Applicant: AUTODESK, INC., San Rafael, CA (US)

(72) Inventors: David BENJAMIN, Brooklyn, NY (US); Dale ZHAO, New York, NY (US); Rui WANG, New York, NY (US)

(21) Appl. No.: 17/696,340

(22) Filed: Mar. 16, 2022

(51) Int. Cl. G06F 30/10

(52) U.S. Cl. CPC G06F 30/10; G06F 2111/02

(57) ABSTRACT

In various embodiments, a computer-implemented method comprises receiving, during a real-time collaboration session including a plurality of participants, a first input associated with a first selectable component from a set of pre-defined selectable components associated with a shared design model, where the first selectable component is associated with a first participant in the plurality of participants, in response to receiving a confirmation of the first input, modifying the shared design model to generate an updated shared design model, wherein the first selectable component in the updated shared design model includes the modified first selectable component, and causing the updated shared design model to be synchronized with at least one other participant in a plurality of participants included in the real-time collaboration session.

### BACKGROUND

### Field of the Various Embodiments

The various embodiments relate generally to computer science and computer-aided design software and, more specifically, to a multi-user collaboration system for generative designs.

### Description of the Related Art

Urban planning involves a large group of stakeholders that have differing goals for a given project. For example, civic leaders, developers, environmentalists, potential tenants, and other stakeholders can be involved in the design and creation of an urban project, such as a city center or a large residential complex. Each of these stakeholders have different goals and metrics that are associated with these goals. For example, a civil servant may focus on access to services provided by the project, while an environmentalist may focus on the carbon footprint imposed by the project. Though such goals are not in direct conflict, the goals of the different stakeholders require a design for a project to balance a large number of different constraints.

When preparing such urban designs, skilled designers use specialized software for architecture, engineering, and construction (AEC) to design structures that have characteristics that meet the goals and constraints of a given project. Such designs involve various tradeoffs between a large number of complex parameters, such as type of materials chosen for specific elements (e.g., use of wood, steel, composite materials for support, etc.), costs, occupancy, and so forth. In order to account for such parameters in the final designs, such skilled designers use generative design software that generates a large set of differing designs that meet the parameters specified by the designer, while differing in at least some of these characteristics. For example, a designer may initially specify a specific material type in a problem specification. The generative design software responds by generating a large set of candidate design solutions to the problem specification that use the selected material type while having different heights, structural weak spots, costs, and so forth. The designer navigates the resultant set of generated designs and iteratively modifies the problem specification before selecting a specific design solution from the group of candidate design solutions.

One drawback of current generative design software is that such software is not configured to enable a multi-user design process. In particular, such software often has a complex interface that is navigable by only experienced designers who have a deep understanding of the design framework. Further, the backend of the design system is often tightly coupled to the complex interface and expects a rigid set of complex input parameters. As a result of this software architecture, current generative design software cannot be extended in a manner that would allow multiple users to collaborate on a single design. Because of this limitation, the designs generated using such generative design software often do not balance or reflect the requirements of all stakeholders in the collaborative process and are often infeasible, incomplete, or both.

As the foregoing illustrates, there is a need in the art for more effective techniques for developing solutions to design problems using generative design systems.

### SUMMARY

One embodiment of the present disclosure sets forth a computer-implemented method comprising receiving, during a real-time collaboration session including a plurality of participants, a first input associated with a first selectable component from a set of pre-defined selectable components associated with a shared design model, where the first selectable component is associated with a first participant in the plurality of participants, in response to receiving a confirmation of the first input, modifying the shared design model to generate an updated shared design model, wherein the first selectable component in the updated shared design model includes the modified first selectable component, and causing the updated shared design model to be synchronized with at least one other participant in a plurality of participants included in the real-time collaboration session

At least one technical advantage of the disclosed techniques relative to the prior art is that, with the disclosed techniques, multiple stakeholders that are not proficient in controlling a generative design can simultaneously provide inputs to a common synchronized framework, greatly improving the process for generating candidate design solutions and selecting a specific design solution. In particular, by using a shared design model that includes an arrangement of pre-defined selectable block items, the generative design system enables multiple designers to modify a shared design model during a real-time collaborative session, while using separate instances of the generative design application. As a result, each stakeholder, including non-proficient designers, can provide inputs and design elements into the generative design system that reflect the specific goals, priorities, and constraints of the stakeholder without requiring a great amount of technical knowledge. Such a system enables the generative design system to generate sets of design solutions that reflect the respective contributions of each stakeholder. These technical advantages provide one or more technological improvements over the prior art.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a distributed computing system configured to implement one or more aspects of the various embodiments.

FIG. 2 is a more detailed illustration of a device including a shared compute instance included in the distributed computing system of FIG. 1, according to various embodiments.

FIG. 3 is a more detailed illustration of a device including a workstation instance included in the distributed computing system of FIG. 1, according to various embodiments.

FIG. 4 is a diagram illustrating interactions between components of a workstation instance included in the distributed computing system of FIG. 1, according to various embodiments.

FIG. 5 illustrates an example user screen provided by a workstation instance of FIG. 1, according to various embodiments.

FIG. 6 illustrates another example user screen provided by a workstation instance of FIG. 1, according to various embodiments.

FIG. 7 illustrates an example visualization of a shared design model included in the distributed computing system of FIG. 1, according to various embodiments.

FIG. 8 illustrates an example user screen for a block item editor included in the workstation of FIG. 1, according to various embodiments.

FIG. 9 illustrates an example user screen of a matrix of candidate design solutions generated by the workstation of FIG. 1, according to various embodiments.

FIG. 10 illustrates an example user screen of a self-organized map of candidate design solutions generated by the workstation of FIG. 1, according to various embodiments.

FIG. 11 illustrates an example user screen for a visualization of the block item editor enhancing a block within the shared design space generated by the workstation of FIG. 1, according to various embodiments.

FIG. 12 sets forth a flow diagram of method steps for modifying a shared design model, according to various embodiments.

FIG. 13 sets forth a flow diagram of method steps for synchronizing a shared design model between multiple workstations, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances of like objects are denoted with reference numbers identifying the object and parenthetical alphanumeric character(s) identifying the instance where needed.

### Overview

Generative design systems include hardware and software components that operate to generate two-dimensional and three-dimensional designs as solutions to a design problem provided by a user. In such systems, the user provides the design problem by generating a problem specification, where the problem specification includes a set of parameters that any given design solution is to meet. The generative design system processes the problem specification and creates a set of design solutions. Each design solution that the generative design system generates meets the parameters of the problem specification, while having different characteristics in the specified parameters and/or other parameters (e.g., different specific values within a range, different values when the design problem does not specify any requirements, etc.). Such generative design systems provide a user with a great degree of control when generating the underlying design problem based on which the set of design solutions is generated. However, such controls to generate the design problem are often overly complex and require that a user have thorough knowledge of the interface and the operation of the system in order to craft problem specifications that reflect the goals, priorities, and constraints of the user. Consequently, only a small subset of highly-skilled designers that are stakeholders for a given project can successfully interact with the generative design system to create the set of design solutions. This causes the skilled designer to be the only user to interact with the generative design system, discouraging collaboration between stakeholders and causing the skilled designer to become a gatekeeper that filters the generated design solutions based on the priorities and goals of the skilled designer above other stakeholders in a project.

Further, such generative design systems are often single-user systems. In practice, a user performs various iterations of crafting the problem specification to define the design problem and triggering the generative design system to optimize the design solutions based on the parameters included in the problem specification. The generative design system may use optimization techniques that automatically filter the set of candidate design solutions to only those candidate solutions that minimize or maximize specific parameters (e.g., Pareto maximum or minimum), further limiting the set of candidate design solutions presented to a user. Such filtering techniques shrink the exploration space that the user may navigate when evaluating candidate designs. Consequently, subsequent users that refine the design problem may only be able to view the subset of design solutions.

To address the above problems, in some embodiments, a distributed computing system includes a plurality of workstations that operate instances of a generative design application. A given generative design application includes a design model editor that modifies a shared design model. The shared design model includes distinct pre-defined, selectable block items made from a set of voxels. A procedural content generation (PCG) engine within the generative design application generates a set of design solutions based on the arrangement of the block items that are included in the shared design model. An evaluation module computes a set of metrics based on the each of the set of generated design solutions and adds each of the generated design solutions to a shared design space. The user explores the set of design solutions in the shared design space via a visualization module and confirms the modifications to the shared design model to generate an updated shared design model. Upon generating the updated shared design model, the generative design application transmits the updated shared design model to a shared compute instance that uses a synchronization module to synchronize the shared design model between workstations. Upon confirming the shared design model the generative design application can render one or more design solution visualizations based on the confirmed shared design model.

### Real-Time Collaborative Generative Design System

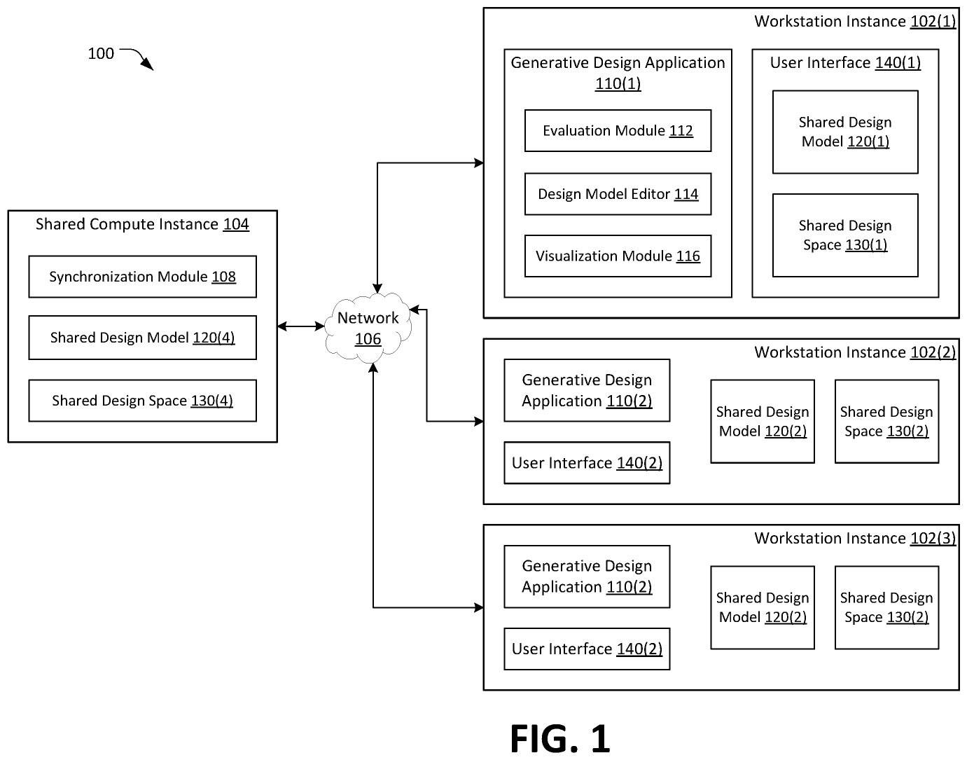

FIG. 1 is a conceptual illustration of a distributed computing system 100 configured to implement one or more aspects of the various embodiments. As shown, in some embodiments, the distributed computing system 100 includes, without limitation, a set of workstation instances 102, a shared compute instance 104, and a network 106. The workstation instances 102 include a generative design application 110 and a user interface 140. The generative design application 110 includes an evaluation module 112, a design model editor 114, and a visualization module 116. The user interface 140 includes a shared design model 120 and a shared design space 130. The shared compute instance 104 includes a synchronization module 108, the shared design model 120, and the shared design space 130.

Any number of the components of the distributed computing system 100 can be distributed across multiple geographic locations or implemented in one or more cloud computing environments (e.g., encapsulated shared resources, software, and data) in any combination. Alternatively, the distributed computing system 100 can be co-located in a shared area and connected via a network switch. In some embodiments, the shared compute instance 104 and/or zero or more other compute instances can be implemented in a cloud computing environment, implemented as part of any other distributed computing environment, or implemented in a stand-alone fashion. For explanatory purposes, multiple instances of like objects are denoted with reference numbers identifying the object and additional numbers identifying the instance where needed (e.g., the workstation instance 102(1)). Further, the distributed computing system 100 includes multiple instances of devices, even when not shown. For example, the distributed computing system 100 could include multiple instances of the generative design applications 110 (e.g., 110(1), 110(2), 110(3) etc.), that each include respective instances of the evaluation module (e.g., 112(1), 112(2), 112(3) etc.), the design model editor 114 (e.g., 114(1), 114(2), 114(3), etc.), and/or the visualization module 116 (e.g., 116(1), 116(2), 116(3), etc.) and still be within the scope of the disclosed embodiments.

In operation, the generative design application 110 executing in the workstation instance 102 receives the shared design model 120 from the shared compute instance 104 as part of a synchronization operation and includes the shared design model 120 in the shared design space 130. The visualization module 116 the shared design space 130 including the shared design model 120 via the user interface 140. The user makes one or more inputs to the shared design model 120, where the design model editor 114 receives the set of user inputs and updates the shared design model 120. The generative design application 110 uses the modified shared design model 120 as a design problem for the generative design application 110. The generative design application 110 processes the modified shared design model 120 and generates a set of candidate design solutions. The evaluation module 112 computes a set of metrics associated with a given candidate design solution. Based on the modified shared design model 120 created by the user, the generative design application 110 optimizes the candidate design solutions and adds the optimized candidate design solutions to the shared design space 130. Once the generative design application 110 adds the candidate design solutions to the shared design space 130, the user explores the set of design solutions in the shared design space 130 via the user interface 140 and the visualization module 116 and confirms the changes to the modified shared design model 120. In various embodiments, the generative design application 110 may further render a more detailed visualization of the modified shared design model 120 once the user confirms the changes.

The workstation instance 102 and the shared compute instance 104 includes one or more processors and memory subsystems. The processors may run various user processes (e.g., the generative design application 110, the user interface 140, etc.) that enable the user to complete various tasks, such as viewing and modifying the shared design model 120 and/or viewing various candidate design solutions in the shared design space 130. The workstation instance 102 is connected to the network 106 via one or more communications channels that transport files, objects, and/or other messages between components. For example, the generative design application 110 could communicate with the synchronization module 108 in the shared compute instance 104 in order to receive updates to the shared design model 120 and/or transmit local changes made by a given user to generate the modified shared design model 120.

The generative design application 110 processes the shared design model 120 as a design problem and generates a set of candidate design solutions. In various embodiments, one or more users of the workstation instances 102(1)-102(3) can use respective local instances of the design model editor 114 to generate local instances of the shared design model 120. In such instances, the generative design application 110 can generate a design problem based on the shared design model 120. In various embodiments, the local instances of the generative design application 110 (e.g., 110(1), 110(2), 110(3), etc.) and/or the synchronization module 108 can interoperate with one another to implement and all of the functionalities of the embodiments described herein.

The design model editor 114 receives inputs from a user and modifies the shared design model 120 by adding, modifying, and/or removing portions of the shared design model 120. In various embodiments, the design model editor 114 generates design model data as an interoperable data set for other modules to interpret without conversion. For example, when the shared design model 120 comprises an arrangement of pre-defined, selectable block items of different types (e.g., three types of ecologist block items, six types of developer block items, etc.) within a three-dimensional grid, the design model editor 114 can convert each selectable block item into a discrete set of coordinates. In such instances, the design model editor 114 generates design model data that includes (i) a list of coordinates and (ii) an identifier for each block item type. For example, when designing an urban block, the design model editor 114 can enable a user to select and place a pre-defined block item representing a park. When the user places a park block item within the shared design model 120, the design model editor 114 stores the design model data for the park block item as an identifier and a set of eight coordinates representing each edge of the park block item.

The shared design model 120 includes a set of pre-defined, selectable block items representing inputs provided by one or more users and edited via the respective design model editors 114. In various embodiments, the shared design model 120 can include an arrangement of a set of pre-defined, selectable block items of different types, where each selectable block item is defined as a set of voxels. For example, a first user can select a block item of a first type that is represented by a cube defined by a set of voxels. The user can add the selected block item to the shared design model 120. In such instances, the shared design model 120 can represent the block item that was added to the shared design model 120 as a set of coordinates representing the edges of the voxel at a specific position within the shared design model 120. In various embodiments, a given block item can be a container of a set of block item programs (BIPs) that include sets of tunable properties and/or actions performed on other block items. For example, a residential building block item could be a block item type that includes a block item program that represents a set of floors capable of containing a tunable number of residents (e.g., apartments of different sizes) within a residential building. A given block item can include a set of parameters or characteristics that affect certain metrics used to compute the performance of the overall design (e.g., capacity, demand for transportation, carbon footprint, etc.) and/or other block items proximate to the given block item (e.g., provides structural support for other block items, blocks access to sunlight of adjacent block items, etc.). In various embodiments, a user can add, move, modify (e.g., enhance an existing block of a different type) and/or delete specific block items that are included in the shared design model 120.

The shared design space 130 includes a set of candidate design solutions that the generative design application 110 generated based on the shared design model 120. In various embodiments, the generative design application 110 can receive the shared design model 120 as a design problem, where the generative design application 110 processes the shared design model 120 as an initial state to generate a large set of candidate design solutions. In various embodiments, the generative design application 110 can iteratively design a large set of candidate design solutions from the same shared design model 120. In some embodiments, the generative design application 110 executes various optimization techniques to add, modify, and/or delete specific block items in the shared design model 120 in order to enhance the overall performance of a given design solution. For example, the generative design application 110 could generate a first candidate design solution that that optimizes the performance of the shared design model 120 by adding multiple park block items adjacent to an existing residential block item within the shared design model 120 in order to reduce the average carbon footprint over all block items included in the shared design model 120 if it were modified to match the first candidate design solution. The generative design application 110 could then generate a second candidate solution that optimizes the performance of the shared design model 120 by enhancing the existing residential building block item such that the residential building block item also includes a retail hub (e.g., replacing the default residential building block item with an enhanced residential building block item), increasing access to services and increasing profitability of the shared design model 120 if it were modified to match the second candidate design solution. In various embodiments, the generative design application 110 provides the shared design space 130 to the visualization module 116 that displays one or more of the candidate design solutions. In such instances, the user can navigate through the set of candidate design solutions within the shared design space 130 in order to confirm any existing modifications made to the shared design model 120, as well as making one or more additional modifications in order for the shared design model 120 to include portions and/or match a specific design solution.

The evaluation module 112 computes a set of metrics associated with the design model data associated with the shared design model 120. For example, the evaluation module 112 can compute specific metrics for a given shared design model 120 based on the arrangement of the block items within the shared design model 120 and generate one or more scores (e.g., one or more performance scores and/or one or more collaboration scores) that reflect the effectiveness of the shared design model 120 to meet the goals and constraints of the project. In some embodiments, the performance score can reflect the effectiveness of the shared design model 120 to meet the goals and constraints of the project. In various embodiments, the evaluation module 112 can also compute one or more behavioral metrics that measure how multiple users effectively collaborated during the real-time collaboration session to generate the shared design model 120. In such instances, the collaboration score that the evaluation module 112 computes a collaboration score than can indicate how well different stakeholders worked collaboratively to optimize the shared design model 120 to enhance the collective goals for the project.

Additionally or alternatively, the evaluation module 112 can further include a recommender that suggests specific modifications to make to the shared design model 120 in order to improve one or more metrics (e.g., portions of the performance score and/or the collaboration score). In some embodiments, the generative design application 110 can include a neural network that maps a specific shared design model 120 to one or more optimized design solutions. In such instances, the recommender can select one of the optimized design solutions and display a comparison of the respective scores generated by the specific shared design model 120 with the corresponding optimized design solution. Additionally or alternatively, the evaluation module 112 can suggest a specific selectable block item to add, modify, or delete, as well as a specific location to place an additional selectable block item in order to optimize the shared design model 120.

The visualization module 116 displays, via the user interface 140, the shared design space 130. In various embodiments, the visualization module 116 displays the shared design model 120 within the shared design space 130. Additionally or alternatively, the visualization module 116 can maintain a design history that is locally stored in a database at the given device (not shown). In some embodiments, the visualization module 116 can maintain one or more self-organized maps (SOMs) that visually represent the set of the candidate design solutions within the shared design space 130. In such instances, the user can explore the set of candidate design solutions within the shared design space 130 by navigating the one or more self-organized maps. In various embodiments, the generative design application 110 adds candidate design solutions to the shared design space 130 via the self-organized map. In various embodiments, the visualization module 116 provides controls to the user interface 140 that enable the user to navigate between individual candidate design models within the self-organized map.

The user interface 140 enables the user to interact with the generative design application 110, the shared design model 120, and/or the shared design space 130. In various embodiments, the user interface 140 uses various techniques to represent the design model data, such as a window-and-object metaphor, a 3D rendering of plain block items, and/or a complex rendering of a 3D landscape corresponding to the arrangement of the block items (e.g., a rendering of a high-rise building to represent a stack of developer block items). Additionally or alternatively, the user interface 140 provides various mechanisms for user interaction with the workstation instance 102. Persons skilled in the art will recognize the various operating systems and user interfaces that are well-known in the art and suitable for incorporation into the workstation instance 102.

The synchronization module 108 processes data associated with the one or more generative design applications 110 and broadcasts changes to one or more devices operating the one or more generative design applications 110. For example, two or more users may be participants in a real-time collaboration session that are operating two or more local instances of the generative design application 110 to modify a shared design model 120. Each of the local instances of the generative design applications 110 generate one or more candidate design solutions for the shared design space 130. In such instances, the synchronization module 108 can receive data associated with actions performed by each user and synchronize the shared design model 120 and/or the shared design space 130 to reflect the changes made by each respective participant. In some embodiments, the synchronization module 108 can maintain a local instance of the shared design model 120 and/or a local instance of the shared design space 130 in the shared compute instance 104. In such instances, the synchronization module 108 can synchronize the shared design model 120 and/or the shared design space 130 by updating the local instance with data received from a given workstation instance 102 (e.g., data received from the workstation instance 102(1)) and can broadcast the updated local instance to the other workstation instances (e.g., 102(2), 102(3)) in order to have the other workstation instances update the local versions of the shared design model 120 and/or the shared design space 130 to match and reflect the updates.

The network 106 can enable communications between the workstation instances 102, the shared compute instance 104, and/or other devices in the network 106 via wired and/or wireless communications protocols, satellite networks, V2X networks, including Bluetooth, Bluetooth low energy (BLE), wireless local area network (WiFi), cellular protocols, and/or near-field communications (NFC).

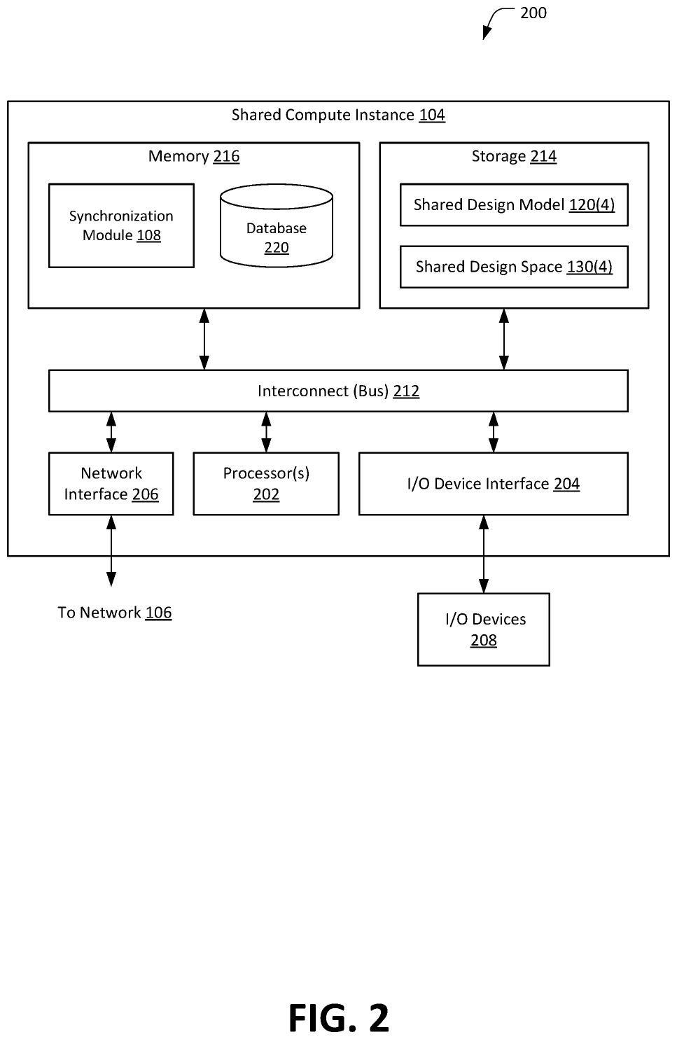

FIG. 2 is a more detailed illustration of a device 200 including the shared compute instance 104 included in the distributed computing system 100 of FIG. 1, according to various embodiments. As shown, and without limitation, the device 200 includes the shared compute instance 104 and a set of input/output devices 208. The shared compute instance 104 includes one or more processors 202, an input/output interface 204, a network interface 206, an interconnect 212 storage 214, and memory 216. The storage 214 includes the shared design model 120(4) and the shared design space 130(4). The memory 216 includes the synchronization module 108 and a database 220.

Shared compute instance 104 includes a desktop computer, a laptop computer, a smart phone, a personal digital assistant (PDA), tablet computer, or any other type of computing device configured to receive input, process data, and optionally display images, and is suitable for practicing one or more embodiments. The shared compute instance 104 described herein is illustrative and that any other technically-feasible configurations fall within the scope of the present disclosure.

The processor(s) 202 includes any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, the processor(s) 202 may be any technically-feasible hardware unit capable of processing data and/or executing software applications. Further, in the context of this disclosure, the computing elements shown in the shared compute instance 104 may correspond to a physical computing system (e.g., a system in a data center) or may be a virtual computing instance executing within a computing cloud.

In one embodiment, the I/O devices 208 include devices capable of providing input, such as a keyboard, a mouse, a touch-sensitive screen, and so forth, as well as devices capable of providing output, such as a display device. Additionally, the I/O devices 208 may include devices capable of both receiving input and providing output, such as a touchscreen, a universal serial bus (USB) port, and so forth. The I/O devices 208 may be configured to receive distinct types of input from a user of the shared compute instance 104, and to also provide distinct types of output to the user of the shared compute instance 104, such as displayed digital images or digital videos or text. In some embodiments, one or more of the I/O devices 208 are configured to couple the shared compute instance to the network 106.

The storage 214 includes non-volatile storage for applications and data, and may include fixed or removable disk drives, flash memory devices, and CD-ROM, DVD-ROM, Blu-Ray, HD-DVD, or other magnetic, optical, or solid-state storage devices. In various embodiments, the synchronization module 108 can be stored in the storage 214 and loaded into the memory 216 when executed. Additionally or alternatively, the storage 214 can store the local instance 120(4) of the shared design model 120 and/or the local instance 130(4) of the shared design space 130.

The memory 216 includes a random-access memory (RAM) module, a flash memory unit, or any other type of memory unit or combination thereof. The processor(s) 202, the I/O device interface 204, and/or the network interface 206 are configured to read data from and write data to the memory 216. The memory 216 includes various software programs that can be executed by the processor(s) 202 and application data associated with said software programs.

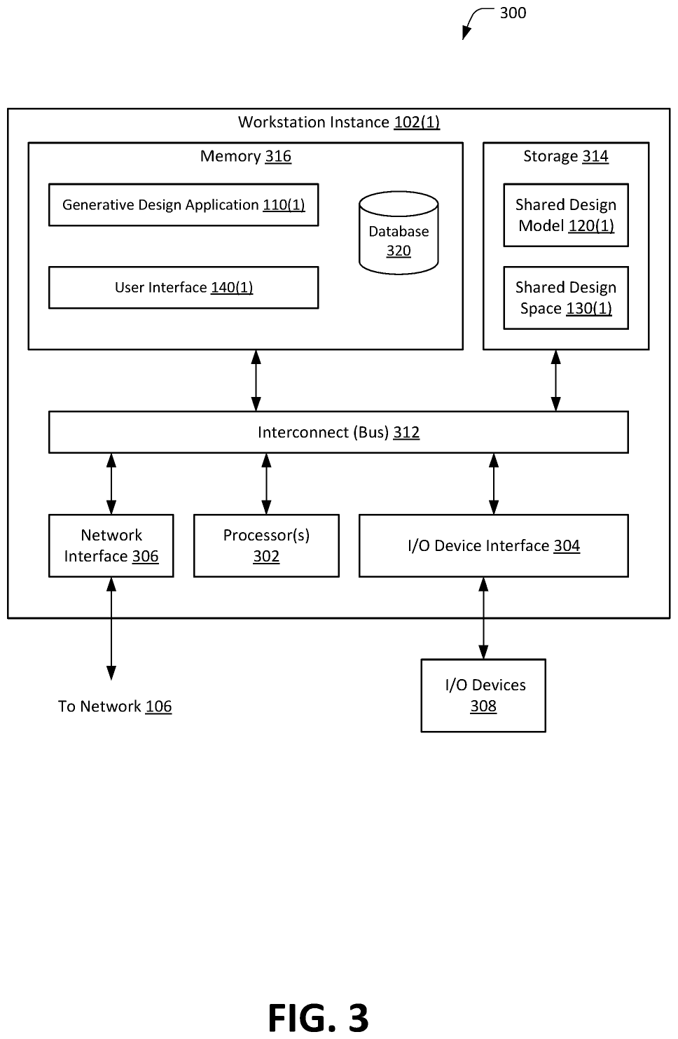

FIG. 3 is a more detailed illustration of a device 300 a workstation instance 102(1) included in the distributed computing system 100 of FIG. 1, according to various embodiments. As shown, and without limitation, the device 300 includes the workstation instance 102(1) and a set of input/output devices 308. The workstation instance 102(1) includes one or more processors 302, an input/output interface 304, a network interface 306, and interconnect 312, storage 314, and memory 316. The storage 314 includes the shared design model 120(1) and the shared design space 130(1). The memory 316 includes the generative design application 110(1), the user interface 140(1), and a database 320.

The workstation instance 102 includes a desktop computer, a laptop computer, a smart phone, a personal digital assistant (PDA), tablet computer, or any other type of computing device configured to receive input, process data, and optionally display images, and is suitable for practicing one or more embodiments. The workstation instances 102 described herein are illustrative and that any other technically-feasible configurations fall within the scope of the present disclosure.

The processor(s) 302 includes any suitable processor implemented as a CPU, a GPU, an ASIC, a FPGA, an AI accelerator, any other type of processing unit, or a combination of different processing units, such as a CPU configured to operate in conjunction with a GPU. In general, the processor(s) 302 may be any technically-feasible hardware unit capable of processing data and/or executing software applications. Further, in the context of this disclosure, the computing elements shown in the workstation instance 102 may correspond to a physical computing system (e.g., a system in a data center) or may be a virtual computing instance executing within a computing cloud.

In one embodiment, the I/O devices 308 include devices capable of providing input, such as a keyboard, a mouse, a touch-sensitive screen, and so forth, as well as devices capable of providing output, such as a display device. Additionally, the I/O devices 308 may include devices capable of both receiving input and providing output, such as a touchscreen, a USB port, and so forth. The I/O devices 308 may be configured to receive distinct types of input from a user of the workstation instance 102, and to also provide distinct types of output to the user of the workstation instance 102, such as displayed digital images or digital videos or text. In some embodiments, one or more of the I/O devices 308 are configured to couple the shared compute instance to the network 106.

The storage 314 includes non-volatile storage for applications and data, and may include fixed or removable disk drives, flash memory devices, and CD-ROM, DVD-ROM, Blu-Ray, HD-DVD, or other magnetic, optical, or solid-state storage devices. In various embodiments, one or more programs, including the generative design application 110 and/or the user interface 140, can be stored in the storage 314 and loaded into the memory 316 when executed. Additionally or alternatively, the storage 314 can store the local instance 120(1) of the shared design model 120 and/or the local instance 130(1) of the shared design space 130.

The memory 316 includes a random-access memory (RAM) module, a flash memory unit, or any other type of memory unit or combination thereof. The processor(s) 302, the I/O device interface 304, and/or the network interface 306 are configured to read data from and write data to the memory 316. The memory 316 includes various software programs that can be executed by the processor(s) 302 and application data associated with said software programs.

### Techniques for Editing a Shared Design Model

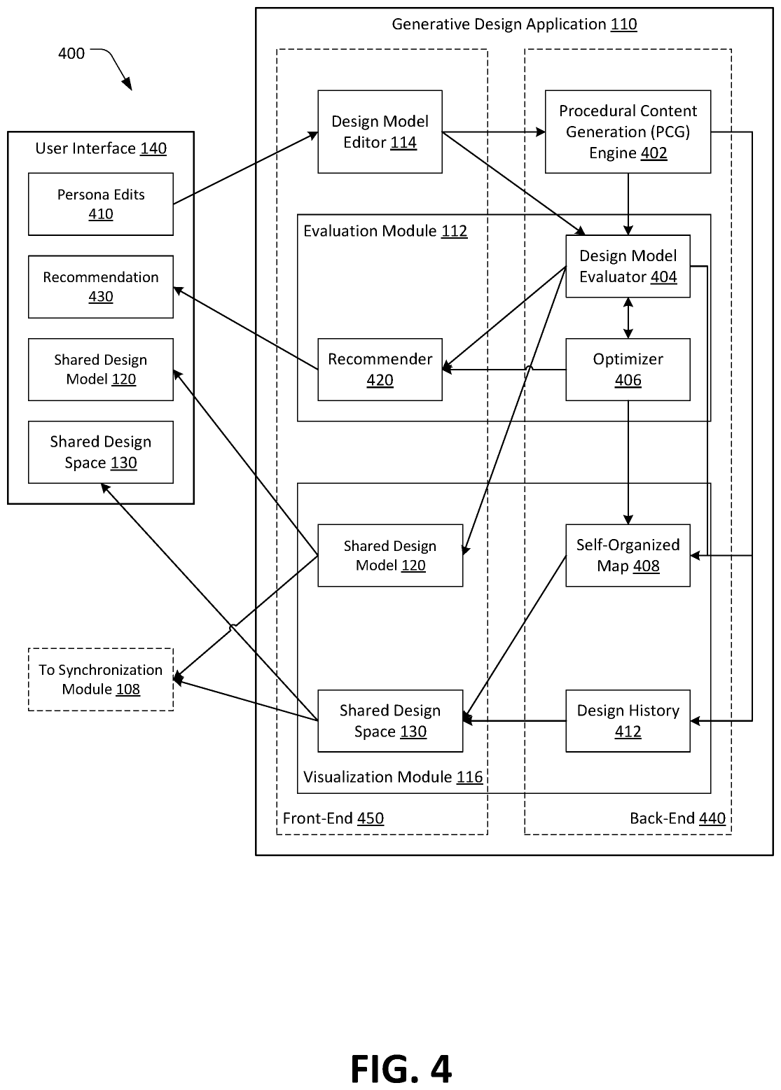

FIG. 4 is a diagram 400 illustrating interactions between components of a workstation instance 102 included in the distributed computing system 100 of FIG. 1, according to various embodiments. As shown, and without limitation, the diagram 400 includes the generative design application 110 and the user interface 140. The generative design application 110 includes the design model editor 114, a procedural content generation (PCG) engine 402, the evaluation module 112, and the visualization module 116. The evaluation module 112 includes a design model evaluator 404, an optimizer 406, and a recommender 420. The visualization module 116 includes a self-organized map 408, a design history module 412, the shared design model 120 and the shared design space 130. The user interface 140 includes a set of persona edits 410, a recommendation 430, the shared design model 120 and the shared design space 130.

In operation, the user interface 140 and the generative design application 110 execute various interaction loops to enable a user to edit the shared design model 120 and explore the shared design space 130 that includes a set of candidate design solutions that the generative design application 110 generates in response to processing the shared design model 120 as a design problem. The generative design application 110 includes a back-end 440 that performs various techniques to generate, modify, and/or store various data structures (e.g., the shared data model 120 and/or the shared design space 130). The components in the back-end 440 provide the data structures to components in the front-end 450 (e.g., provide optimized candidate design solutions to the recommender 420), where the front-end components provide the information to the user via the user interface 140.

In various embodiments, the generative design application 110 can enable the user to perform a specific subset of inputs (e.g., edits to the shared design model 120) based on a specific persona associated with the project. For example, a project to design an urban space can include at least three separate personas (e.g., city planner, commercial developer, community ecologist, etc.) that have different goals, priorities, and capabilities. A user acting under a given persona has a specific set of capabilities, such as the ability to make a subset of inputs, like selecting, placing, and/or removing one or more pre-defined persona-specific block items. For example, in various embodiments, only a user operating the ecologist persona can select and place an urban park block item within the shared design model 120. In such instances, only the user operating the ecologist persona can remove the urban park block item from the shared design model 120. Further, only a specific persona can make persona-specific enhancements to existing blocks. For example, only a user operating under the city planner persona can enhance an existing ecologist-type block item by enhancing the existing block item to include an algae production area. Similarly, only a user operating under the city planner persona can enhance an existing developer block item by causing the existing developer block to further include solar roofs.

Based on the persona the user is employing, the user generates a set of persona edits 410 in order to modify the shared design model 120. For example, the user generates a set of persona edits 410 by adding a selectable block item to a specific position within the grid of the shared design model 120. The user interface 140 transmits the persona edits 410 to the design model editor 114. The design model editor 114 modifies the shared design model 120 with the persona edits 410, generating a modified shared design model 120 represented by a set of design model data that the design model editor 114 transmits to the PCG engine 402.

The procedural content generation (PCG) engine 402 is a geometry generation engine that uses the set of design model data corresponding to a given shared design model 120 as a design problem to generate a set of candidate design solutions. In such instances, the PCG engine 402 treats the set of design model data as an initial state, where the PCG engine 402 performs various operations to produce a series of generative designs in real-time in response to the set of design model data. For example, the PCG engine 402 can generate thousands of different candidate design solutions by starting each candidate design solution from the same set of design model data received from the design model editor 114.

The design model evaluator 404 computes metrics for each candidate design solution that the PCG engine 402 generates. For example, when the PCG engine 402 performs thousands of iterations to generate a large set of candidate design solutions, the design model evaluator 404 computes metrics for each of the candidate design solutions. The design model evaluator 404 transmits the candidate design solution and the set of computed metrics to other modules in the generative design application 110. For example, the design model evaluator 404 can compute a set of performance metrics (e.g., one or more characteristics based on the arrangement of the block items) in order to compute an overall performance score for a given candidate design solution. For example, in some embodiments, the performance metrics for an urban design can include a set of social metrics (e.g., public spaces & amenities, views & visibility, noise exposure, etc.), a set of ecological metrics (e.g., amount of green space, amount of daylight, energy & food, etc.) and/or a set of economic metrics (e.g., number of jobs, number of residents, access to amenities, etc.).

Additionally or alternatively, the design model evaluator 404 can compute one or more behavior metrics in order to compute collaboration scores for participants in the real-time collaboration session. In such instances, design model evaluator 404 can compute behavior metrics that measure how well different pairs of participants provided separate persona edits 410 to the shared design model 120 in order to enhance the collective goals of the group. In such instances, the design model evaluator 404 can combine separate collaboration scores (e.g., separate collaboration scores between the city planner & ecologist, ecologist & developer, and developer & city planner, respectively) to compute an overall collaboration score for the group of participants.

The optimizer 406 performs various optimization techniques to modify one or more candidate design solutions generated by the PCG engine 402 in order to optimize the performance metrics of a given candidate design solution. In various embodiments, the group of participants collaborate to prioritize specific performance metrics for the shared design model 120. In such instances, the optimizer 406 can modify one or more aspects of a candidate design solution that the PCG engine 402 generated and the design model evaluator 404 evaluated in order to maximize or minimize one or more performance metrics. For example, the optimizer 406 can move a residential block item included in a given candidate design solution to a different position in the candidate design solution in order to maximize the amount of light received by the shared design model 120 as a whole. Additionally or alternatively, the optimizer 406 can perform the optimization techniques in real time as the PCG engine 402 generates candidate design solutions in real time.

The recommender 420 receives the set of design model data via the design model evaluator 404, as well as one or more optimized design solutions from the optimizer 406. In various embodiments, the recommender 420 suggests specific modifications to make to the shared design model 120 in order for the user to make a modified shared design model 120 that matches one of the optimized design solutions. In some embodiments, the evaluation module 112 can include a neural network (not shown) that maps the set of design model data for a given shared design model 120 made by the group of participants to one or more optimized design solutions. In such instances, the recommender 420 can select one of the optimized design solutions and cause the user interface 140 to display a comparison of performance scores of the designs. For example, the recommender 420 can cause the user interface 140 to display the current performance metrics associated with the set of design model data for a current shared design model 120 with a set of performance metrics computed for a specific optimized candidate design solution. Additionally or alternatively, in some embodiments, the recommender 420 can cause the user interface 140 to highlight position at which to add a pre-defined electable block item (e.g., adding a residential building block item over a commercial building block item), and/or highlight an existing block item within the shared design model 120 to enhance in order to modify the current shared design model 120 to match the optimized candidate design solution.

The visualization module 116 displays the shared design space 130 that includes the shared design model 120. In various embodiments, the PCG engine 402 and/or the evaluation module 112 add candidate design solutions and/or optimized candidate design solutions to the self-organized map (SOM) 408 and/or the design history module 412 for the visualization module 116 to display a set of candidate design solutions within the shared design space 130. In such instances, the visualization module 116 can use the design history module 412 to maintain a design history that is locally stored in the database 320. Additionally or alternatively, the visualization module 116 provides controls to the user interface 140 that enable the user to navigate between individual candidate design models and/or previous candidate design models from the design history within the shared design space 130. In such instances, the user can navigate the shared design space 130 in order to see how changes to the shared design model 120 over time by the respective personas has modified the performance metrics of the candidate design solutions.

The visualization module 116 maintains one or more self-organized maps 408 that visually represent the candidate design solutions generated by the PCG engine 402 and/or the optimizer 406. In such instances, the user can use the user interface 140 to navigate within one or more of the self-organized maps 408, where a given self-organized map 408 visually represents the shared design space 130. In some embodiments, the PCG engine 402 and/or the optimizer 406 adds the candidate design solutions to the shared design space 130 via the self-organized map 408. Alternatively, in other embodiments, the PCG engine 402 and/or the optimizer 406 add candidate solutions directly to the shared design space 130 and the visualization module 116 generates one or more self-organized maps 408 from the shared design space 130.

The user interface 140 enables the user to interact with components of the generative design application 110, the shared design model 120, and/or the shared design space 130. In various embodiments, the user interface 140 uses various techniques to represent the design model data, such as a window-and-object metaphor, a 3D rendering of plain block items, and/or a complex rendering of a 3D landscape corresponding to the arrangement of the block items. Additionally or alternatively, the user interface 140 provides various mechanisms for user interaction with the workstation instance 102. For example, upon receiving a shared design model 120 as part of a synchronization technique performed by the synchronization module 108, the user interface 140 provides a shared design space 130 that includes the shared design model 120. The user interface 140 provides navigation tools to explore portions of the shared design model 120, as well as navigation tools to explore other candidate design solutions that are within the shared design space 130. The user interface 140 further provides editing tools that enable the user to provide the persona edits 410 to the design model editor 114 in order to generate a modified shared design model 120 to initiate the PCG engine 402 to generate new candidate design solutions based on a set of design model data representing the modified shared design model 120.

In some embodiments, the user interface 140 displays a visualization of the PCG engine 402 and/or the optimizer 406 performing techniques to generate new candidate design models and/or optimized candidate design models in real time within the shared design space 130. Upon viewing the updated shared design space 130, the user can confirm the persona edits 410 and cause the shared design model 120 to be updated to reflect the persona edits 410. Upon updating the shared design model 120 and/or the shared design space 130, the generative design application 110 can transmit the updated shared design model 120 and/or the shared design space 130 to the synchronization module 108.

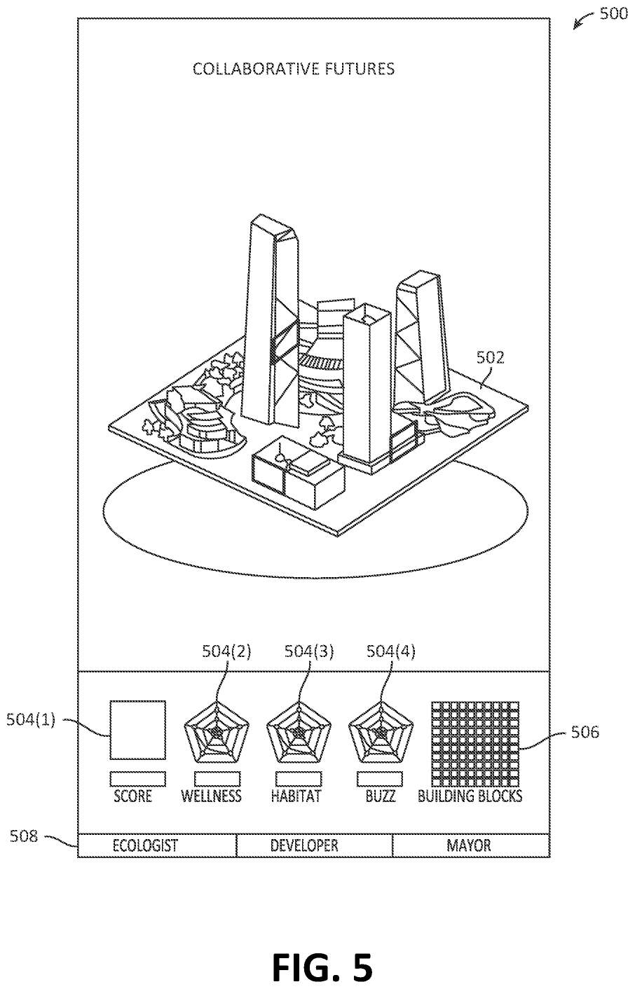

FIG. 5 illustrates an example user screen 500 provided by a workstation instance 102 of FIG. 1, according to various embodiments. As shown, and without limitation, the user screen 500 includes a city block visualization 502 based on the shared design model 120, a set of scores 504 (e.g., 504(1), 504(2), etc.) based on the shared design model 120, a remaining blocks indicator 506 and persona indicators 508.

In operation, the generative design application 110 causes the user interface 140 to present the user screen 500 that reflects the shared design model 120. In some embodiments, at least one of the generative design applications 110 causes the shared compute instance 104 to display the user screen 500 while the workstation instances 102 display different user screens.

The city block visualization 502 is a visual rendering of a city space based on the arrangement of the pre-defined selectable block items of different types that are included in the shared design model 120. In various embodiments, the generative design application 110 can cause the PCG engine 402 to generate a candidate design solution as a city block rendering in lieu of a visualization of the arrangement of block items. In such instances, the city block visualization 502 replaces each block item with a corresponding high-resolution rendering that is associated with the block item type. For example, the PCG engine 402 may render a stack of four commercial building blocks as a skyscraper commercial building. In another example, the PCG engine 402 may render a park above a commercial building as an urban park installed on a roof of a commercial building.

The scores 504 indicate the real-time scores that the design model evaluator 404 computed for the shared design model 120. In various embodiments, the design model evaluator 404 can compute separate subsets of metrics, as well as one or more comprehensive metrics. For example, the score 504(1) indicates an overall performance score associated with the current city block visualization 502. The wellness scores 504(2) indicates the relative set of social metrics associated with the city planner personas. The habitat scores 504(3) indicates the relative set of ecological metrics associated with the ecologist persona. The buzz scores 504(4) indicates the relative set of economic metrics associated with the developer persona. Various embodiments can include other sets of metrics and other personas (e.g., safety metrics associated with a police or hazard management person).

In various embodiments, each persona may add pre-defined, selectable block items of specific types. Such pre-defined, selectable block items may include characteristics that affect the scores of other block items and/or the overall score. For example, a waste management block item (associated with the city planner persona) may include characteristics that either positively or negatively affect other subsets of characteristics, such as negatively affecting economic metrics and/or positively affecting ecological metrics. In some embodiments, the evaluation module 112 may also provide a collaboration score that encourages collaborative behavior between individual personas in order to have multiple participants balance the sets of metrics and increase the overall performance score.

The remaining blocks indicator 506 indicates the overall number of block items available for all of the participants in the real-time collaboration session to place. In some embodiments, each persona may have an equal number of block items to place in the shared design model 120. Alternatively, the generative design application 110 may have a general pool of block items from which the respective participants draw from when modifying the shared design model 120. In such instances, a given persona may place more blocks based on the overall priorities of all the stakeholders. For example, if the primary goal of the project includes quantity of residents and amount of retail space, the developer persona may draw from the remaining blocks more often in order for the group to reach the high-priority goal.

The persona indicators 508 highlight the distinctive types of pre-defined, selectable block items within the city block visualization 502 that correspond to the respective personas. For example, the types of selectable block items in the city block visualization 502 that correspond to the ecologist persona may have an overlay that matches the pattern of the ecologist persona indicator 508. In some embodiments, the city block visualization 502 may show overlay over the most-recently placed block item corresponding to each of the respective personas.

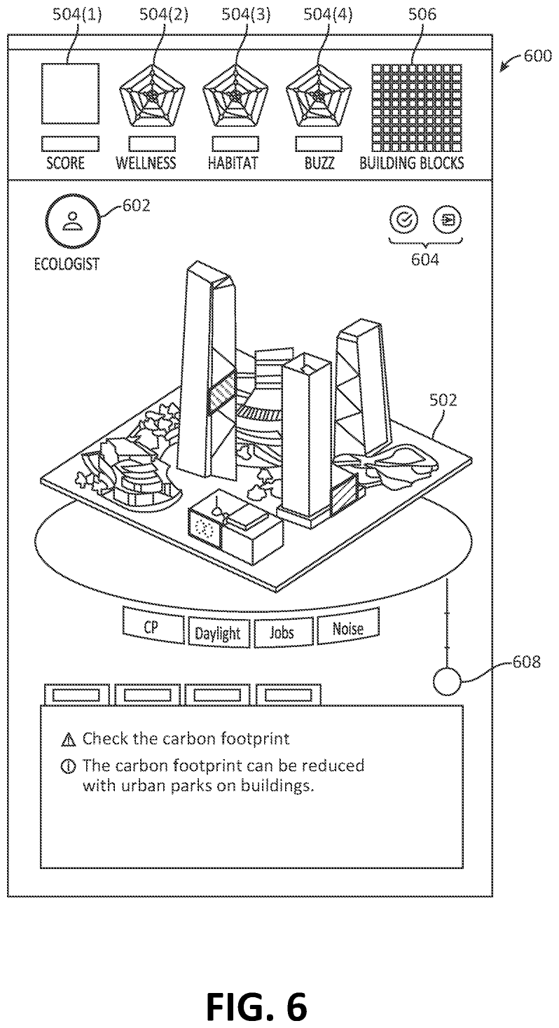

FIG. 6 illustrates another example user screen 600 provided by a workstation instance of FIG. 1, according to various embodiments. As shown, and without limitation, the user screen 600 includes the city block visualization 502, the set of scores 504, the remaining blocks indicator 506, a persona indicator 602, a set of group actions 604, a set of overlays 606, a design space slider 608, and an information panel 610.

In operation the generative design application 110 causes the user interface 140 to present the user screen 600 that reflects the shared design model 120. In some embodiments, at least one of the generative design applications 110 causes the shared compute instance 104 to display the user screen 500 for the collective group while a given workstation instances 102 (e.g., 102(2)) displays the user screen to a single participant acting under a single persona.

The persona indicator 602 displays, to the participant, the current persona that the participant is employing for the real-time collaboration session. In some embodiments, a single participant can switch between two or more personas during the real-time collaboration session. For example, a representative for the city can switch between the city planner persona in order to place civic-type block items and the ecologist persona in order to place ecological-type block items. In such instances, a user can select an icon to switch between the personas.

The group actions 604 enable a user to perform an action associated with the group. In various embodiments, the generative design application 110 can wait to confirm group consensus before rendering a final design solution based on the shared design model 120. In such instances, each participant can confirm or deny consensus using one of the buttons corresponding to a group action 604. Once all participants confirm consensus, the generative design application 110 can provide final scores based on the shared design model 120 that was confirmed by all the participants.

The overlays 606 indicate distinct types of overlays to place over the city block visualization 502. In some embodiments, the overlays 606 can represent a specific metric (e.g., carbon footprint), or a specific set of metrics (e.g., set of ecological scores). In such instances, a participant can switch between overlays by selecting a specific overlay 606.

The design space slider 608 indicates the current zoom level of that city block visualization 502 relative to the design space. In various embodiments, the user can slide the slider to zoom in and out and view distinct types of self-organized maps that display portions of the shared design space 130.

The information panel 610 displays additional information associated with the shared design model 120 and/or the shared design space 130. In various embodiments, the information panel can 610 indicate the goals, capabilities, priorities, and constraints of a given persona. The information panel 610 may also provide additional information on the types of selectable block items that are available for a given persona to select and place in the shared design model 120. For example, a developer persona can view information on a set of pre-defined block items, such as high-density commercial, low-density commercial, high-density residential, low-density residential block items. The information displayed within the information panel 610 can include the characteristics of a given type of pre-defined, selectable block item, as well as recommendations for where to place a given block item type based on the current state of the shared design model 120.

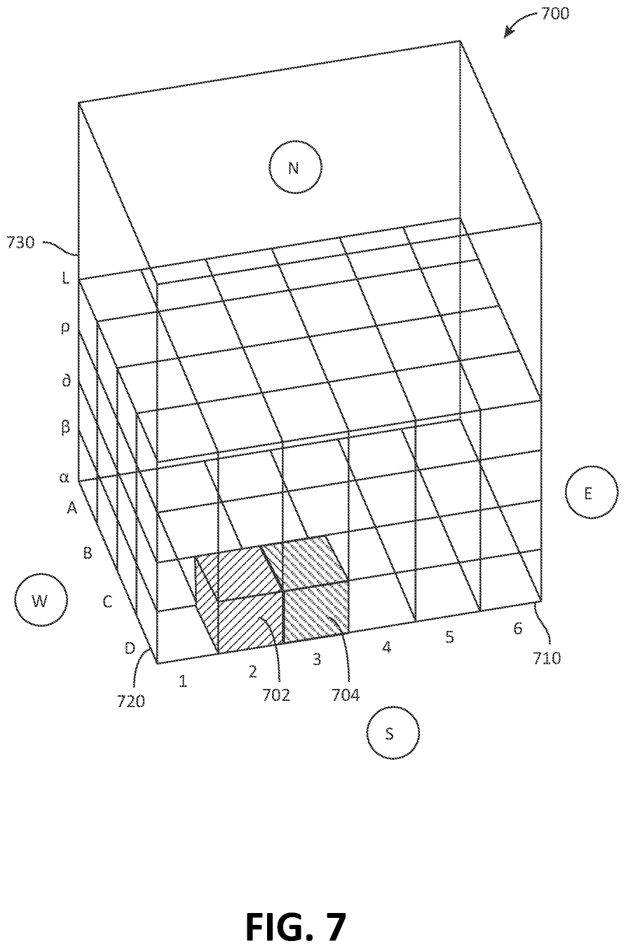

FIG. 7 illustrates an example visualization 700 of a shared design model 120 included in the distributed computing system of FIG. 1, according to various embodiments. As shown and without limitation, the visualization 700 includes a first axis 710, a second axis 720, and a third axis 730. The grid includes a first block item 702 and a second block item 704.

In operation, each persona can add and/or delete one or more block items within the grid representing the shared design model 120. For example, a first persona can place the first block item 702 corresponding to a pre-defined, selectable block item of a first type. The second persona can add the second block item 704 corresponding to a pre-defined, selectable block item of a second type. The design model editor 114 receives one or more persona edits 410 that are associated with placing, modifying (e.g., enhancing), and/or removing block items 702, 704 from the grid.

In various embodiments, the design model editor 114 generates a set of design model data based on coordinate data for each block item included in the grid. For example, the design model editor 114 can identify the location of the first block item 702 based on the faces of the block item (e.g., D, α, 2). Alternatively, the design model editors 114 can identify the location of the first block item 702 based on the sets of coordinates corresponding to each edge. When the design model editor 114 generates the set of design model data, the design model data includes the coordinates for each of the respective block items.

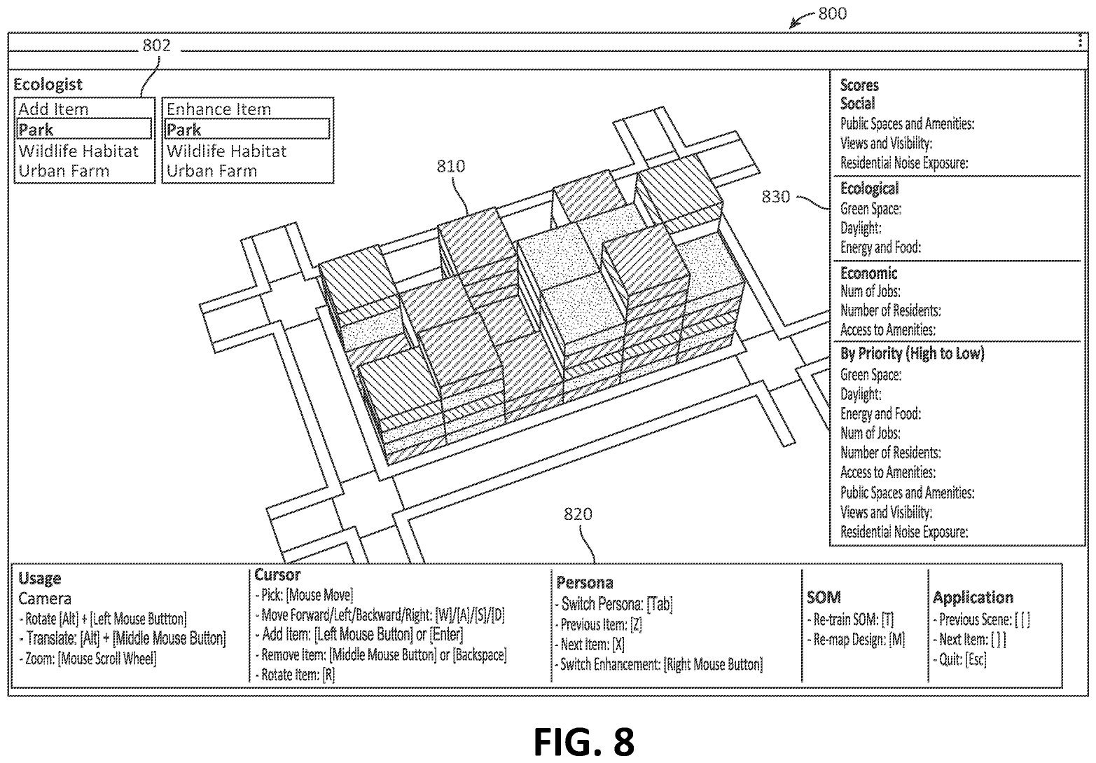

FIG. 8 illustrates an example user screen 800 for a design model editor 114 included in the workstation instance 102 of FIG. 1, according to various embodiments. As shown, the user screen 800 includes a block item menu 802, a city grid 810, a participant action panel 820 and a scoring panel 830.

In operation, the generative design application 110 causes the user interface 140 to present the user screen 800 in order to enable a participant to modify the shared design model 120. For example, a participant employing the ecologist persona can use the block item menu 802 to select a specific block item type (e.g., park, habitat, or urban farm), to add to a level of the city grid 810.

In various embodiments, the generative design application 110 can cause the user screen 800 to display a participant action panel 820 that includes controls to perform actions associated with the shared design model 120 and/or the shared design space 130. For example, the participant action panel 820 include actions to add, move, and/or remove block items, move the camera, change the candidate design solutions in the shared design space 130, and exit the generative design application 110.

In some embodiments, the generative design application 110 can also include a score panel 830 that identifies the specific metrics computed for the shared design model 120. In some embodiments, the design model evaluator 404 can update the scores in real time as a participant modifies the city grid 810. In some embodiments, the score panel 830 lists the priority order of the metrics that the design model evaluator 404 uses when computing the overall performance score for the shared design model 120. For example, the score panel 830 can list specific property values (e.g., P=0.400) that are respectively assigned to each metric. In such instances, the design model evaluator 404 can weigh higher-priority metrics more than lower-priority metrics. Additionally or alternatively, the design model evaluator 404 can dynamically evaluate the priorities based on the performance of the shared design model 120. For example, when the shared design model 120 consumes a larger quantity of energy, the design model evaluator 404 may cause the carbon footprint score to be a higher priority than for shared design models 120 that consume less energy.

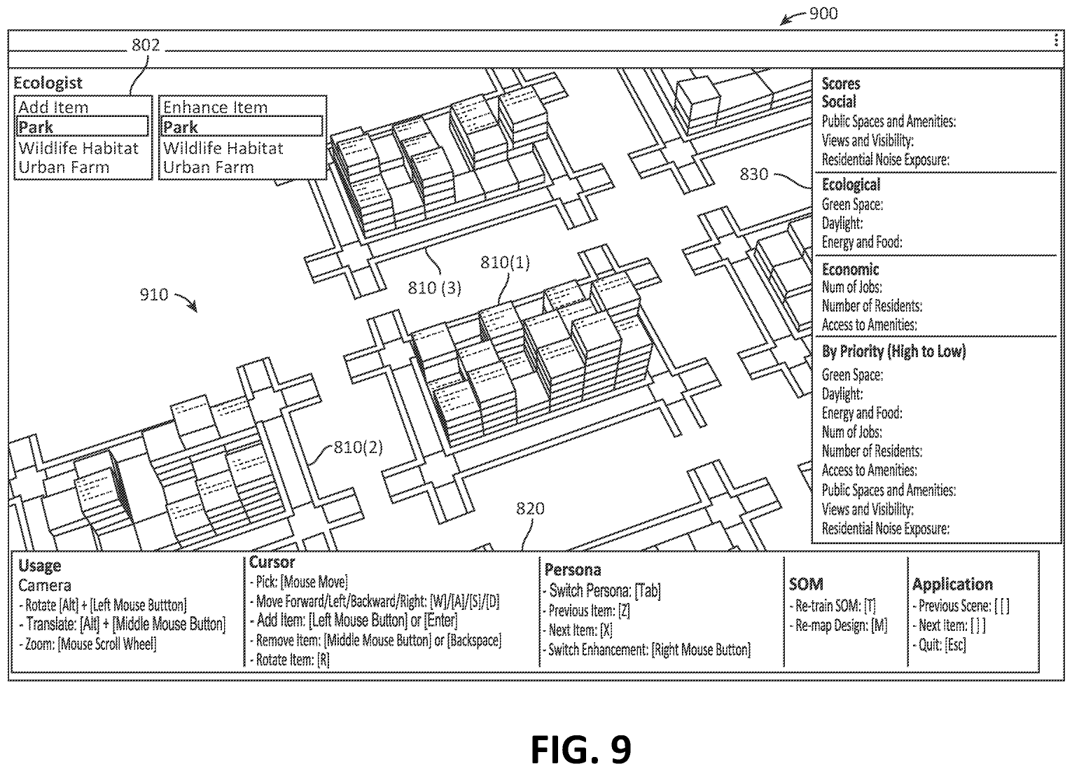

FIG. 9 illustrates an example user screen 900 of a matrix of candidate design solutions generated by the workstation of FIG. 1, according to various embodiments. As shown, the user screen 900 includes the block item menu 802, a matrix 910 of the city grids 810, the participant action panel 820, and the scoring panel 830.

In operation, a participant can zoom out of the user screen 800 to see a portion of a matrix 910 that includes a subset of the candidate design solutions (represented by separate city grids 810(1), 810(2), 810(3), etc.) generated by the PCG engine 402. In various embodiments, the participant can use various navigation controls to navigate between individual city grids 810. In such instances, the generative design application 110 can cause the scoring panel 830 to update the metric values to reflect the computed metrics for the particular city grid that is the main focus of the matrix 910.

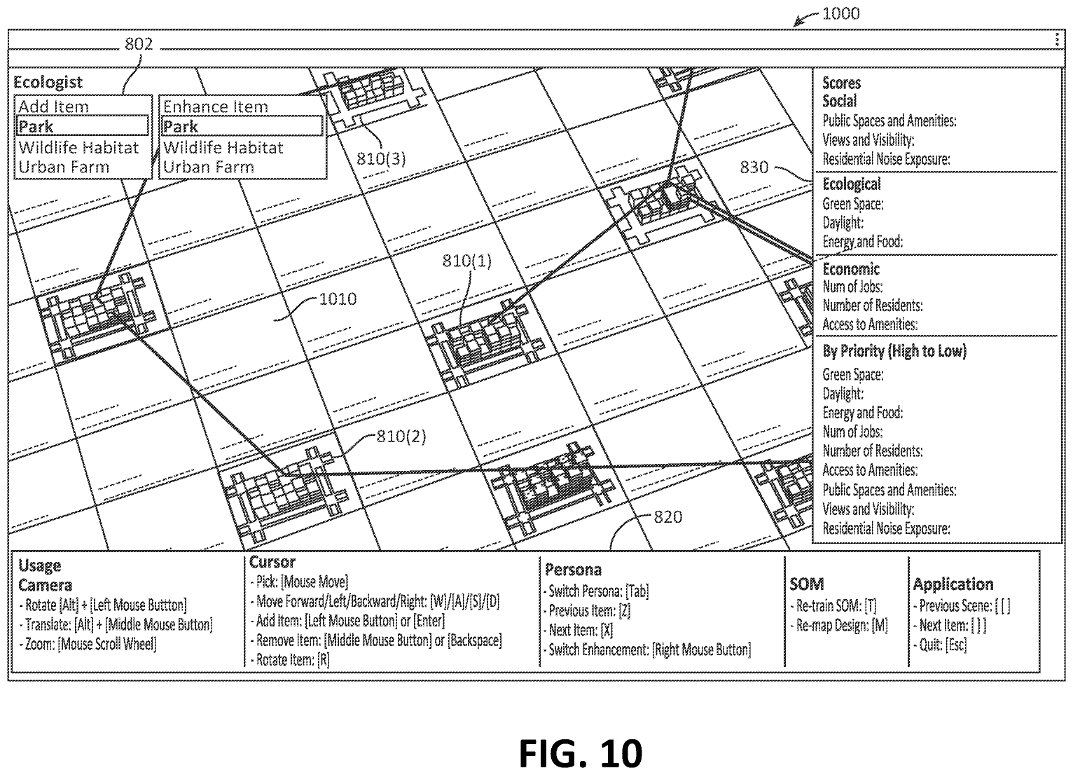

FIG. 10 illustrates an example user screen of a self-organized map of candidate design solutions generated by the workstation of FIG. 1, according to various embodiments. As shown, the user screen 1000 includes the block item menu 802, a self-organized map 1010 of city grids 810, the participant action panel 820, and the scoring panel 830.

In operation, the participant can zoom out from the matrix 910 to view a self-organized map 1010. In some embodiments, the self-organized map 1010 can organize the respective city grids 810 along one or more axes based on characteristics associated with each of the respective city grids 810. For example, the city grids 810 can be organized along a first axis based on an amount of green space. In some embodiments, the self-organized map 1010 can assign city grids 810 to adjacent positions based on each of a set of characteristics.

In some embodiments, each position may be colored based on an aggregation of the features of the shared design models 120 located at the position within the self-organized map 1010. For example, each city grid 810 located within one quadrant may be colored similarly based on similar performance scores based on one or more characteristics. Alternatively, some embodiments, each square may be colored based on a third characteristic (e.g., number of residents). A participant can navigate within the self-organized map 1010 in order to view the relative characteristics of the candidate design solutions that the PCG engine 402 and/or the optimizer 406 created.

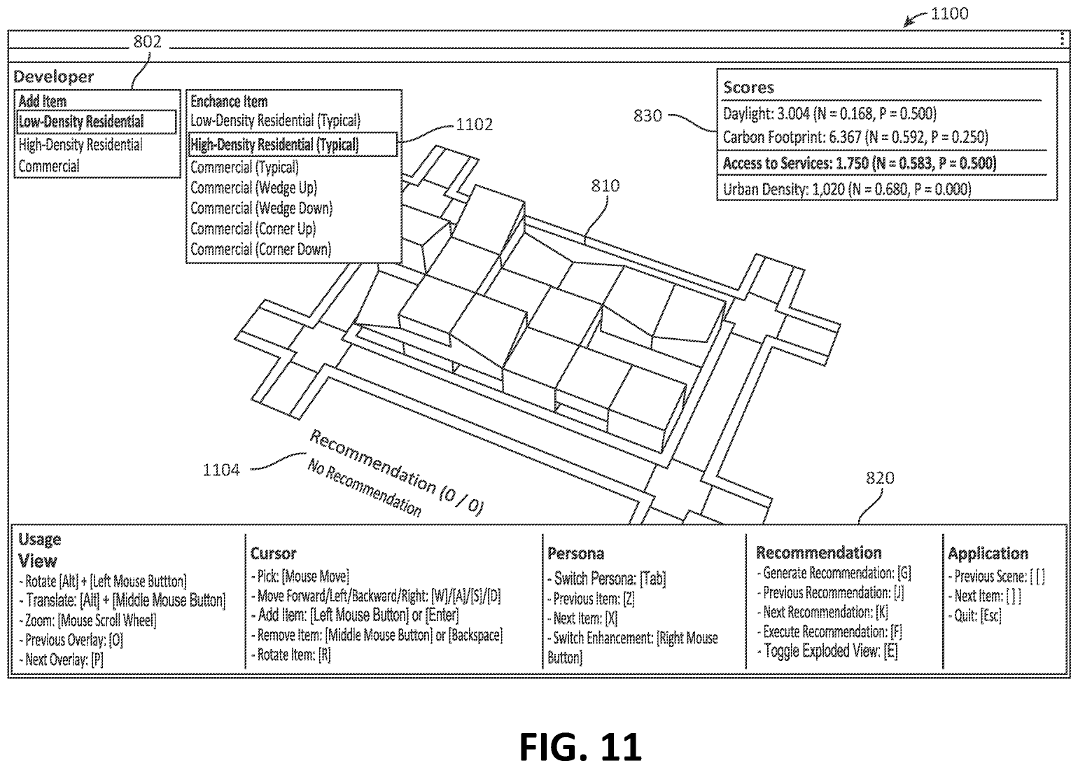

FIG. 11 illustrates an example user screen 1100 for a visualization of the design model editor 114 enhancing a shared design model 120 within the shared design space 130 generated by the workstation instance 102 of FIG. 1, according to various embodiments. As shown, and without limitation, the example user screen 1100 includes block item menu 802, the city grid 810, the participant action panel 820, the scoring panel 830, an enhance block item menu 1102, and a recommendation 1104.

In operation, the recommender 420 included in the generative design application 110 can compare the shared design model 120 to one or more candidate design solutions, such as an optimized candidate design solution that the optimizer 406 generated. In some embodiments, the recommender 420 can employ a neural network that maps the shared design model 120 to the optimized design model solutions and selects a specific optimized design model solution based on the mappings. In such instances, the recommender 420 can provide a recommendation 1104 in order to increase the performance score associated with the shared design model 120.

Additionally or alternatively, the participant can select a specific enhancement block item from the enhance block item menu 1102. The enhancement block item enhances an existing block of a different type on the shared design model 120 in order to increase the performance of the existing block. For example, a developer persona can select an urban farm block item by enhancing the urban farm block item to further include a research center. In some embodiments, use of an enhancement block item decreases the number of available blocks. Alternatively, use of enhancement block items does not decrease the number of available blocks. Participants can use the enhancement block items to increase the overall performance score of the shared block item 120 as well as increasing the collaboration score with respect to another persona (e.g., the developer enhancing an education campus block item to increase the city planner-developer collaboration score).

### Techniques for Generating a Shared Design Model

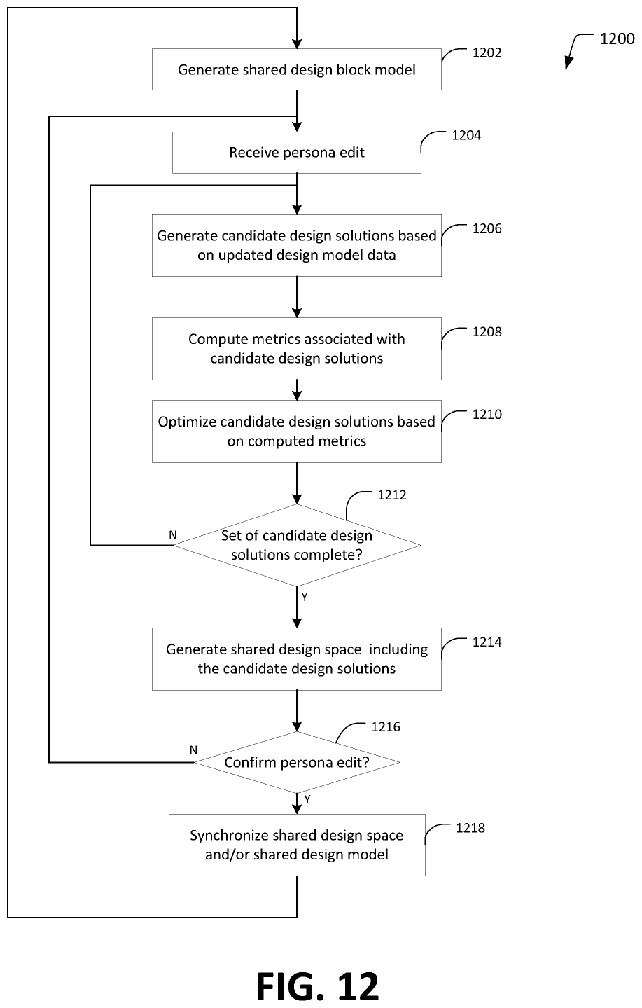

FIG. 12 sets forth a flow diagram of method steps for modifying a shared design model, according to various embodiments. Although the method steps are described with reference to the systems of FIGS. 1-11, persons skilled in the art will understand that any system configured to implement the method steps, in any order, falls within the scope of the disclosed embodiments.

As shown, a method 1200 begins at step 1202, where the generative design application 110 generates a shared design model 120. In various embodiments, the generative design application 110 within a given workstation instance 102 (e.g., the generative design application 110(2) included in the workstation instance 102(2)) can receive a shared design model 120 as part of a synchronization technique performed by the synchronization module 108. In such instances, the generative design application 110 can generate the shared design model 120 by updating a local instance of the shared design model 120 (e.g., the shared design model 120(2)) to reflect the shared design model 120(4) received from the synchronization module 108. Additionally or alternatively, the generative design application 110 can generate a new instance of the shared design model 120 at the initiation of a real-time collaboration session between two or more participants.

At step 1204, the generative design application 110 receives one or more persona edits 410 to the shared design model 120. In various embodiments, the user interface 140 included in the workstation instance 102 can provide a shared design space 130 that includes the shared design model 120. The generative design application 110 includes a design model editor 114 that receives one or more inputs representing edits made by a user. In various embodiments, the design model editor 114 can enable the user to perform a subset of inputs based on a persona associated with the project, where a user acting under a given persona has a specific set of capabilities, such as the ability to add, modify, enhance, and/or remove persona-specific block items. Based on the persona the user is employing, the user generates a set of persona edits 410 to modify the shared design model 120.

At step 1206, the generative design application 110 generates one or more candidate design solutions based on updated design model data. In various embodiments, upon receiving the persona edits 410, the user interface 140 transmits the persona edits 410 to the design model editor 114 to modify the shared design model 120 with the persona edits 410, generating a modified shared design model 120 that is represented by a set of design model data that the design model editor 114 transmits to the PCG engine 402. The PCG engine 402 uses the set of design model data corresponding to the modified shared design model 120 as a seed to generate a set of candidate design solutions. In such instances, the PCG engine 402 treats the set of design model data as a design problem and the PCG engine 402 performs a series of generative designs in real-time in response to the set of design model data. For example, the PCG engine 402 can generate thousands of different candidate design solutions from the same set of design model data received from the design model editor 114.

At step 1208, the generative design application 110 computes, for each candidate design solution, a set of metrics. In various embodiments, for each candidate design solution that the PCG engine 402 generates, the design model evaluator 404 included in the generative design application 110 computes a set of metrics in order to compute an overall performance score for a given candidate design solution. For example, when generating designs for an urban development project, the design model evaluator 404 can compute a set of social metrics, a set of ecological metrics, and/or a set of economic metrics associated with a candidate design solution that the PCG engine 402 generates. In some embodiments, the design model evaluator 404 can compute one or more collaboration scores that measure how well different pairs of participants have optimized the shared design model 120 in collaboration in order to enhance the collective goals of the group. In such instances, the design model evaluator 404 can combine separate collaboration scores (e.g., separate collaboration scores between the persona 1 & persona 2, persona 2 & persona 3, and persona 3 & persona 1, respectively) to compute an overall collaboration score.

At step 1210, the generative design application 110 optimizes one or more candidate design solutions based on the set of metrics. In various embodiments, an optimizer 406 included in the generative design application 110 can perform various optimization techniques to modify one or more candidate design solutions generated by the PCG engine 402 in order to optimize the performance metrics of a given candidate design solution. In various embodiments, the optimizer 406 can modify one or more aspects of a candidate design solution generated by the PCG engine 402 and evaluated by the design model evaluator 404 in order to maximize or minimize specific metrics associated with the shared design model 120. For example, the optimizer 406 can move a residential block item to a different position in a given candidate design solution in order to maximize the amount of light received by the shared design model 120 as a whole. Additionally or alternatively, the optimizer 406 can perform the optimization techniques in real time as the PCG engine 402 generates candidate design solutions in real time.

At step 1212, the generative design application 110 determines whether the set of candidate design solutions is complete. In various embodiments, the PCG engine 402 can iteratively generate a large set of candidate design solutions based on the set of design model data provided by the design model editor 114. In such instances, the generative design application 110 can determine whether the PCG engine 402 has completed its generation of all the candidate design solutions. When the generative design application 110 determines that the set of candidate design solutions is complete, the generative design application 110 proceeds to step 1214. Otherwise, the generative design application 110 determines that the set of candidate design solutions is not complete and returns to step 1206 to perform another iteration.

At step 1214, the generative design application 110 generates an updated shared design space 130 that includes the set of candidate design solutions. In various embodiments, a visualization module 116 included in the generative design application 110 displays the shared design space 130 that includes the shared design model 120. In various embodiments, the PCG engine 402 and/or the evaluation module 112 add candidate design solutions and/or optimized candidate design solutions to the self-organized map (SOM) 408 and/or the design history module 412. In such instances, the visualization module 116 can use the design history module 412 to maintain a design history that is locally stored in the database 320. Additionally or alternatively, the visualization module 116 provides controls to the user interface 140 that enable the user to navigate between individual candidate design models and/or previous candidate design models from the design history within the shared design space 130. In such instances, the user can navigate the shared design space 130 in order to see how changes to the shared design model 120 over time by the respective personas has modified the performance of the shared design model 120.

The visualization module 116 maintains one or more self-organized maps 408 that visually represent the candidate design solutions generated by the PCG engine 402 and/or the optimizer 406. In such instances, the user can use the user interface 140 to navigate within one or more of the self-organized maps 408, where a given self-organized map 408 visually represents the shared design space 130. In some embodiments, the PCG engine 402 and/or the optimizer 406 adds the candidate design solutions to the shared design space 130 via the self-organized map 408. Alternatively, in other embodiments, the PCG engine 402 and/or the optimizer 406 add candidate design solutions directly to the shared design space 130 and the visualization module 116 generates one or more self-organized maps 408 from the shared design space 130.

At step 1216, the generative design application 110 determines whether the user has confirmed the one or more persona edits 410. In various embodiments, upon viewing the updated shared design space 130, the user can confirm the persona edits 410 that the user made to the shared design model 120. When the generative design application 110 determines that the user confirmed the persona edits, the generative design application 110 proceeds to step 1218. Otherwise, the generative design application 110 determines that the user rejected the persona edits 410 and returns to step 1204 to receive additional personal edits 410.

At step 1218, the generative design application 110 synchronizes the modified shared design model 120 and/or the shared design space 130 with other participants. In various embodiments, the generative design application 110 can cause the shared design model 120 to be modified to reflect the persona edits 410. Upon updating the shared design model 120 and/or the shared design space 130, the generative design application 110 can transmit the modified shared design model 120 and/or the shared design space 130 to the synchronization module 108. In such instances, the synchronization module 108 can update the local instances of the shared design model 120 and/or the shared design space 130 and broadcast the updates to the other participants.

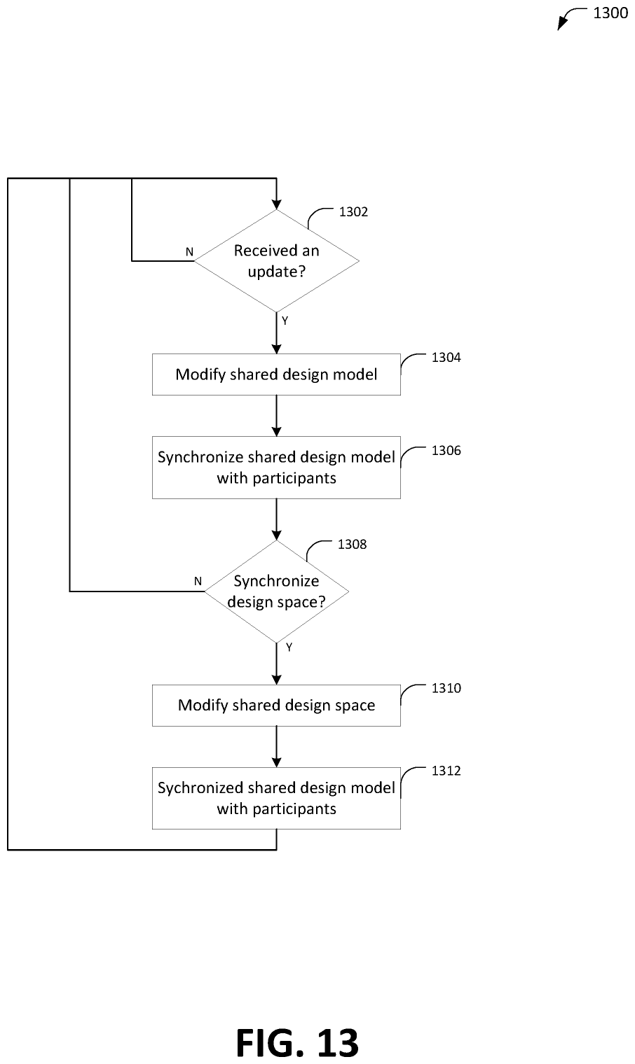

FIG. 13 sets forth a flow diagram of method steps for synchronizing a shared design model between multiple workstations, according to various embodiments. Although the method steps are described with reference to the systems of FIGS. 1-11, persons skilled in the art will understand that any system configured to implement the method steps, in any order, falls within the scope of the disclosed embodiments.

As shown, a method 1300 begins at step 1302, where the shared compute instance 104 determines whether an update was received. In various embodiments, the synchronization module 108 determines whether one or more of the workstation instances 102 has transmitted an update to the shared design model 120 and/or the shared design space 130. When the synchronization module 108 that the shared compute instance 104 received an update, the synchronization module 108 proceeds to step 1304. Otherwise, the synchronization module 108 determines that the shared compute instance 104 did not receive an update to the shared design model 120 and proceeds to step 1304.

At step 1304, the shared compute instance 104 updates the shared design model 120. In various embodiments, the synchronization module 108 can cause the shared compute instance 104 to update a local instance of the shared design model 120 (e.g., the shared design model 120(4)). In such instances, the local instance 120(4) can serve as a source of truth during the real-time collaboration session. Additionally or alternatively, the synchronization module 108 can receive overlapping updates. For example, the synchronization module 108 can receive updates from the workstation instances 102(2), 102(3) before synchronizing the shared design model 120. In such instances, the synchronization module 108 can perform both updates to the shared design model 120. Alternatively, the synchronization module 108 can perform only one of the updates. For example, if two participants attempt to place a block item at the same location, the synchronization module 108 can update the shared design model 120 with the first update and refrain from placing the second block item in a different location.

At step 1306, the synchronization module 108 synchronizes the shared design model 120 with the participants in the real-time collaboration session. In various embodiments, the synchronization module 108 can synchronize the instances of the shared design model 120 for participants in the real-time collaboration session by broadcasting the update to each participant. In some embodiments, the synchronization module 108 can perform the synchronization by broadcasting the local instance 120(4) of the shared design model 120. Alternatively, in some embodiments, the synchronization module 108 may forward the update data received from one participant to the other participants. In such instances, the respective generative design applications 110 can separately update the respective instances of the shared design model 120.

At step 1308, the synchronization module 108 determines whether to optionally synchronize the shared design space 130. In various embodiments, the synchronization module 108 can cause each of the respective generative design applications 110 to maintain a shared design space 130 that includes the shared design model 120 and one or more candidate design solutions that at least one instance of the PCG engine 402 and/or at least one instance of the optimizer 406 generated. When the synchronization module 108 determines to synchronize the shared design space 130, the synchronization module 108 proceeds to step 1310. Otherwise, the synchronization module 108 determines not to synchronize the shared design space 130 and returns to step 1302 to wait for an additional update.

At step 1310, the synchronization module 108 modifies the shared design space 130. In various embodiments, the synchronization module 108 can cause the shared compute instance 104 to update a local instance of the shared design space 130 (e.g., the shared design space 130(4)). In such instances, the local instance 130(4) can serve as a source of truth for the shared design space 130 during the real-time collaboration session.

At step 1312, the synchronization module 108 synchronizes the shared design space 130 with the participants in the real-time collaboration session. In various embodiments, the synchronization module 108 can synchronize the instances of the shared design space 130 for participants in the real-time collaboration session by broadcasting the update to each participant. In some embodiments, the synchronization module 108 can perform the synchronization by broadcasting the local instance 130(4) of the shared design space 130. Alternatively, in some embodiments, the synchronization module 108 may forward, to the other participants, the update data associated with the shared design space 130 that was received from one participant. In such instances, the respective generative design applications 110 can separately update the respective instances of the shared design space 130.

In sum, the disclosed techniques enable efficient real-time collaboration of participants to collectively generate and modify a common design problem used to generate design solutions for a collaborative project. A distributed computing system includes a plurality of workstations that operate instances of a generative design application. A given generative design application includes a design model editor that responds to one or more user inputs by modifying a local instance of a shared design model. A procedural content generation engine within the generative design application processes the shared design model and generates a set of candidate design solutions based on the components included in the shared design model. In some embodiments, when the shared design model is a voxel-based model that is represents design characteristics using pre-defined, selectable block items of distinct types, the procedural content generation engine uses the shared design model as an initial state to place additional block items within the shared design model to generate a candidate design solution. An evaluation module computes a set of metrics based on a given candidate design solution and adds the candidate design solution to a shared design space.

The user explores the set of candidate design solutions in the shared design space via a visualization module and confirms the one or more modifications that the user made to the shared design model. The generative design application generates a modified shared design model to reflect the one or more modifications. Upon generating the modified shared design model, the generative design application transmits the modified shared design model to a shared compute instance that uses a synchronization module to synchronize the shared design model with all the participants in the real-time collaboration session.

At least one technical advantage of the disclosed techniques relative to the prior art is that, with the disclosed techniques, multiple stakeholders that are not proficient in controlling a generative design can simultaneously provide inputs to a common synchronized framework, greatly improving the process for generating candidate design solutions and selecting a specific design solution. In particular, by using a shared design model that includes an arrangement of pre-defined selectable block items, the generative design system enables multiple designers to modify a shared design model during a real-time collaborative session, while using separate instances of the generative design application. As a result, each stakeholder, including non-proficient designers, can provide inputs and design elements into the generative design system that reflect the specific goals, priorities, and constraints of the stakeholder without requiring a great amount of technical knowledge. Such a system enables the generative design system to generate sets of design solutions that reflect the respective contributions of each stakeholder. These technical advantages provide one or more technological improvements over the prior art.
1. In various embodiments, a computer-implemented method for generating a design model shared between multiple participants comprises receiving, during a real-time collaboration session including a plurality of participants, a first input associated with a first selectable component from a set of pre-defined selectable components associated with a shared design model, where the first selectable component is associated with a first participant in the plurality of participants, in response to receiving a confirmation of the first input, modifying the shared design model to generate an updated shared design model, where the first selectable component in the updated shared design model includes the modified first selectable component, and causing the updated shared design model to be synchronized with at least one other participant in a plurality of participants included in the real-time collaboration session.
2. The computer-implemented method of clause 1, further comprising adding the shared design model to a shared design space, generating, based on the shared design model and the first input, a first set of candidate design solutions that includes additional selectable components from the set of pre-defined selectable components, adding the first set of candidate design solutions to a shared design space, and displaying at least a portion of the shared design space.
3. The computer-implemented method of clause 1 or 2, further comprising computing, for each candidate design solution included in the first set of candidate design solutions, a set of metrics associated with the performance of the candidate design solution, where the shared design model includes an arrangement of a set of block items including (i) a first block item comprising a pre-defined selectable component of a first type having a first set of characteristics, and (ii) a second block item comprising a pre-defined selectable component of a second type having a second set of characteristics that is different than the first set of characteristics, and the set of metrics is computed based on one or more sets of characteristics included in the arrangement of the set of block items.
4. The computer-implemented method of any of clauses 1-3, further comprising performing, on at least one candidate design solution in the first set of candidate design solutions, one or more optimization operations to generate an optimized candidate design solution, where the optimized candidate design solution maximizes or minimizes the set of metrics associated with the performance of the candidate design solution.
5. The computer-implemented method of any of clauses 1-4, where causing the updated shared design model to be synchronized comprises causing the at least one of the first input or the updated shared design model to be broadcasted to the at least one other participant in the plurality of participants.
6. The computer-implemented method of any of clauses 1-5, where a synchronization service receives the at least one of the first input or the updated shared design model, and modifies, based on the at least one of the first input or the updated shared design model, a local instance of the shared design model to match the updated shared design model.
7. The computer-implemented method of any of clauses 1-6, where the synchronization service receives, before updating the local instance of the shared design model based on at least one of the first input or the updated shared design model, at least one of a second input or a second updated design model, updates the local instance of the shared design model to generate an updated local instance of the shared design model, where the updated local instance of the shared design model is based on both (i) the at least one of the input or the updated shared design model, and (ii) the at least one of the second input or the second updated design model, and transmitting the updated local instance of the shared design model to the at least one other participant.
8. The computer-implemented method of any of clauses 1-7, further comprising adding the shared design model to a shared design space, generating, based on the shared design model and the first input, a first set of candidate design solutions, adding the first set of candidate design solutions to a shared design space, and causing the shared design space to be synchronized with the at least one other participant, wherein a synchronization service receives the shared design space and broadcasts the shared design space to the at least one other participant in the plurality of participants.
9. The computer-implemented method of any of clauses 1-8, where the shared design model includes an arrangement of a set of block items, each block item included in the set of block items is defined by at least one of the selectable components from the set of pre-defined selectable components comprising a set of voxels defined by one or more sets of edges, and each pre-defined selectable component is associated with one participant in the plurality of participants.
10. The computer-implemented method of claim 9, where the set of block items includes a first block item comprising a pre-defined selectable component of a first type having a first set of characteristics, and a second block item comprising a pre-defined selectable component of a second type having a second set of characteristics that is different than the first set of characteristics.
11. In various embodiments, one or more non-transitory computer-readable media store instructions that, when executed by one or more processors, cause the one or more processors to generate a design model shared between multiple participants by performing the steps of receiving, during a real-time collaboration session including a plurality of participants, a first input associated with a first selectable component from a set of pre-defined selectable components associated with a shared design model, where the first selectable component is associated with a first participant in the plurality of participants, in response to receiving a confirmation of the first input, modifying the shared design model to generate an updated shared design model, wherein the first selectable component in the updated shared design model includes the modified first selectable component, and causing the updated shared design model to be synchronized with at least one other participant in a plurality of participants included in the real-time collaboration session.
12. The one or more non-transitory computer-readable media of clause 11, further comprising instructions that, when executed by the one or more processors, cause the one or more processors to perform the steps of adding the shared design model to a shared design space, generating, based on the shared design model and the first input, a first set of candidate design solutions that includes additional selectable components from the set of pre-defined selectable components, adding the first set of candidate design solutions to a shared design space, and displaying at least a portion of the shared design space.
13. The one or more non-transitory computer-readable media of clause 11 or 12, further comprising instructions that, when executed by the one or more processors, cause the one or more processors to perform the step of computing, for each candidate design solution included in the first set of candidate design solutions, a set of metrics associated with the performance of the candidate design solution, where the shared design model includes an arrangement of a set of block items including (i) a first block item comprising a pre-defined selectable component of a first type having a first set of characteristics, and (ii) a second block item comprising a pre-defined selectable component of a second type having a second set of characteristics that is different than the first set of characteristics, and the set of metrics is computed based on one or more sets of characteristics included in the arrangement of the set of block items.
14. The one or more non-transitory computer-readable media of any of clauses 11-13, where a first participant is associated with a first persona in a plurality of personas, only the first persona is capable of placing the pre-defined selectable components of the first type in the shared design model, and the set of metrics is weighted based on the first persona.
15. The one or more non-transitory computer-readable media of any of clauses 11-14, where displaying the shared design space comprises displaying a map that includes a subset of the first set of candidate design solutions.
16. The one or more non-transitory computer-readable media of any of clauses 11-15, where the first set of candidate design solutions are organized along one or more axes based on a set of metrics associated with the respective candidate design solutions.
17. The one or more non-transitory computer-readable media of any of clauses 11-16, where causing the updated shared design model to be synchronized comprises causing the at least one of the first input or the updated shared design model to be broadcasted to the at least one other participant in the plurality of participants.
18. In various embodiments, a system for generating a design model shared between multiple participants in a real-time collaboration session comprises a memory storing a generative design application, and a processor coupled to the memory that executes the generative design application by performing the steps of receiving, during a real-time collaboration session including a plurality of participants, a first input associated with a first selectable component from a set of pre-defined selectable components associated with a shared design model, wherein the first selectable component is associated with a first participant in the plurality of participants, in response to receiving a confirmation of the first input, modifying the shared design model to generate an updated shared design model, wherein the first selectable component in the updated shared design model includes the modified first selectable component, and causing the updated shared design model to be synchronized with at least one other participant in a plurality of participants included in the real-time collaboration session.
19. The system of clause 18, where the processor further executes the generative design application to perform the steps of adding the shared design model to a shared design space, generating, based on the shared design model and the first input, a first set of candidate design solutions that includes additional selectable components from the set of pre-defined selectable components, adding the first set of candidate design solutions to a shared design space, and displaying at least a portion of the shared design space.
20. The system of clause 18 or 19, where causing the updated shared design model to be synchronized comprises causing the at least one of the first input or the updated shared design model to be broadcasted to the at least one other participant in the plurality of participants.

Any and all combinations of any of the claim elements recited in any of the claims and/or any elements described in this application, in any fashion, fall within the contemplated scope of the embodiments and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments. Aspects of the present embodiments can be embodied as a system, method, or computer program product. Accordingly, aspects of the present disclosure can take the form of an entirely hardware embodiment, an entirely software embodiment (including firmware, resident software, and micro-code, etc.) or an embodiment combining software and hardware aspects that can all generally be referred to herein as a “module,” a “system,” or a “computer.” In addition, any hardware and/or software technique, process, function, component, engine, module, or system described in the present disclosure can be implemented as a circuit or set of circuits. Furthermore, aspects of the present disclosure can take the form of a computer program product embodied in one or more computer readable media having computer readable program codec embodied thereon.

Any combination of one or more computer readable media can be utilized. Each computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory, a read-only memory, an erasable programmable read-only memory, a Flash memory, an optical fiber, a portable compact disc read-only memory, an optical storage device, a magnetic storage device, or any suitable combination of the foregoing. In the context of this document, a computer readable storage medium can be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow.

What is claimed is:

1. A computer-implemented method for generating a design model shared between multiple participants, the method comprising:
receiving, during a real-time collaboration session including a plurality of participants, a first input associated with a first selectable component from a set of pre-defined selectable components associated with a shared design model, wherein the first selectable component is associated with a first participant in the plurality of participants;
in response to receiving a confirmation of the first input, modifying the shared design model to generate an updated shared design model, wherein the first selectable component in the updated shared design model includes the modified first selectable component; and
causing the updated shared design model to be synchronized with at least one other participant in a plurality of participants included in the real-time collaboration session.

2. The computer-implemented method of claim 1, further comprising:
adding the shared design model to a shared design space;
generating, based on the shared design model and the first input, a first set of candidate design solutions that includes additional selectable components from the set of pre-defined selectable components;
adding the first set of candidate design solutions to a shared design space; and
displaying at least a portion of the shared design space.

3. The computer-implemented method of claim 2, further comprising computing, for each candidate design solution included in the first set of candidate design solutions, a set of metrics associated with the performance of the candidate design solution, wherein:
the shared design model includes an arrangement of a set of block items including (i) a first block item comprising a pre-defined selectable component of a first type having a first set of characteristics, and (ii) a second block item comprising a pre-defined selectable component of a second type having a second set of characteristics that is different than the first set of characteristics, and
the set of metrics is computed based on one or more sets of characteristics included in the arrangement of the set of block items.

4. The computer-implemented method of claim 3, further comprising:
performing, on at least one candidate design solution in the first set of candidate design solutions, one or more optimization operations to generate an optimized candidate design solution,
wherein the optimized candidate design solution maximizes or minimizes the set of metrics associated with the performance of the candidate design solution.

5. The computer-implemented method of claim 1, wherein causing the updated shared design model to be synchronized comprises:
causing the at least one of the first input or the updated shared design model to be broadcasted to the at least one other participant in the plurality of participants.

6. The computer-implemented method of claim 5, wherein a synchronization service:
receives the at least one of the first input or the updated shared design model; and
modifies, based on the at least one of the first input or the updated shared design model, a local instance of the shared design model to match the updated shared design model.

7. The computer-implemented method of claim 6, wherein the synchronization service:
receives, before updating the local instance of the shared design model based on at least one of the first input or the updated shared design model, at least one of a second input or a second updated design model;
updates the local instance of the shared design model to generate an updated local instance of the shared design model, wherein the updated local instance of the shared design model is based on both (i) the at least one of the input or the updated shared design model, and (ii) the at least one of the second input or the second updated design model; and
transmitting the updated local instance of the shared design model to the at least one other participant.

8. The computer-implemented method of claim 1, further comprising:
adding the shared design model to a shared design space;
generating, based on the shared design model and the first input, a first set of candidate design solutions;
adding the first set of candidate design solutions to a shared design space; and
causing the shared design space to be synchronized with the at least one other participant, wherein a synchronization service receives the shared design space and broadcasts the shared design space to the at least one other participant in the plurality of participants.

9. The computer-implemented method of claim 1, wherein:
the shared design model includes an arrangement of a set of block items;
each block item included in the set of block items is defined by at least one of the selectable components from the set of pre-defined selectable components comprising a set of voxels defined by one or more sets of edges; and
each pre-defined selectable component is associated with one participant in the plurality of participants.

10. The computer-implemented method of claim 9, wherein the set of block items includes:
a first block item comprising a pre-defined selectable component of a first type having a first set of characteristics, and
a second block item comprising a pre-defined selectable component of a second type having a second set of characteristics that is different than the first set of characteristics.

11. One or more non-transitory computer-readable media storing instructions that, when executed by one or more processors, cause the one or more processors to generate a design model shared between multiple participants by performing the steps of:
receiving, during a real-time collaboration session including a plurality of participants, a first input associated with a first selectable component from a set of pre-defined selectable components associated with a shared design model, wherein the first selectable component is associated with a first participant in the plurality of participants;
in response to receiving a confirmation of the first input, modifying the shared design model to generate an updated shared design model, wherein the first selectable component in the updated shared design model includes the modified first selectable component; and
causing the updated shared design model to be synchronized with at least one other participant in a plurality of participants included in the real-time collaboration session.

12. The one or more non-transitory computer-readable media of claim 11, further comprising instructions that, when executed by the one or more processors, cause the one or more processors to perform the steps of:
adding the shared design model to a shared design space;
generating, based on the shared design model and the first input, a first set of candidate design solutions that includes additional selectable components from the set of pre-defined selectable components;
adding the first set of candidate design solutions to a shared design space; and
displaying at least a portion of the shared design space.

13. The one or more non-transitory computer-readable media of claim 12, further comprising instructions that, when executed by the one or more processors, cause the one or more processors to perform the step of computing, for each candidate design solution included in the first set of candidate design solutions, a set of metrics associated with the performance of the candidate design solution, wherein:
the shared design model includes an arrangement of a set of block items including (i) a first block item comprising a pre-defined selectable component of a first type having a first set of characteristics, and (ii) a second block item comprising a pre-defined selectable component of a second type having a second set of characteristics that is different than the first set of characteristics, and
the set of metrics is computed based on one or more sets of characteristics included in the arrangement of the set of block items.

14. The one or more non-transitory computer-readable media of claim 13, wherein:
a first participant is associated with a first persona in a plurality of personas;
only the first persona is capable of placing the pre-defined selectable components of the first type in the shared design model, and
the set of metrics is weighted based on the first persona.

15. The one or more non-transitory computer-readable media of claim 12, wherein displaying the shared design space comprises displaying a map that includes a subset of the first set of candidate design solutions.

16. The one or more non-transitory computer-readable media of claim 15, wherein the first set of candidate design solutions are organized along one or more axes based on a set of metrics associated with the respective candidate design solutions.

17. The one or more non-transitory computer-readable media of claim 11, wherein causing the updated shared design model to be synchronized comprises:
causing the at least one of the first input or the updated shared design model to be broadcasted to the at least one other participant in the plurality of participants.

18. A system for generating a design model shared between multiple participants in a real-time collaboration session, the system comprising:
a memory storing a generative design application; and
a processor coupled to the memory that executes the generative design application by performing the steps of:
receiving, during a real-time collaboration session including a plurality of participants, a first input associated with a first selectable component from a set of pre-defined selectable components associated with a shared design model, wherein the first selectable component is associated with a first participant in the plurality of participants;
in response to receiving a confirmation of the first input, modifying the shared design model to generate an updated shared design model, wherein the first selectable component in the updated shared design model includes the modified first selectable component; and
causing the updated shared design model to be synchronized with at least one other participant in a plurality of participants included in the real-time collaboration session.

19. The system of claim 18, wherein the processor further executes the generative design application to perform the steps of:
adding the shared design model to a shared design space;
generating, based on the shared design model and the first input, a first set of candidate design solutions that includes additional selectable components from the set of pre-defined selectable components;
adding the first set of candidate design solutions to a shared design space; and
displaying at least a portion of the shared design space.

20. The system of claim 18, wherein causing the updated shared design model to be synchronized comprises:
causing the at least one of the first input or the updated shared design model to be broadcasted to the at least one other participant in the plurality of participants.
